(19) United States
(12) Patent Application Publication
(10) Pub. No.: US 2018/0255198 A1
(43) Pub. Date: Sep. 6, 2018

(54) IMAGE FORMING APPARATUS AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Akira TAKANO, Mishima (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/465,779

(22) Filed: Mar. 22, 2017

(30) Foreign Application Priority Data
Mar. 1, 2017 (JP) 2017-038392

(51) Int. Cl. H04N 1/23; H04N 1/00; H04N 1/028

(52) U.S. Cl. CPC H04N 1/2307; H04N 1/02815; H04N 1/00034; H04N 1/00018

(57) ABSTRACT

According to one embodiment, an image forming apparatus includes an image reading unit, a recognition unit, and an image data generation unit. The image reading unit generates image data by reading an original document image having a first image which is formed by a first recording agent emitting light under ultraviolet light and a second image which is formed by a second recording agent that is readable under visible light. The recognition unit recognizes position information of the second image from image data of the first image which is read by the image reading unit. The image data generation unit generates corrected image data which is obtained by correcting image data of the second image based on the position information.

### CROSS-REFERENCE TO RELATED APPLICATIONS

This application claims the benefit of priority from Japanese Patent Application No. 2017-038392, filed Mar. 1, 2017, the entire contents of which are incorporated herein by reference.

### TECHNICAL FIELD

Embodiments described herein relate generally to an image forming apparatus and an image forming method.

### BACKGROUND

If a copy machine reads an image of an original document in a state where the original document is placed on a feeder or original document table glass, an image tilted with respect to an output medium such as a sheet can be copied due to the fact that the original document is placed or transported in a tilted state with respect to a reference read position.

Meanwhile, pigment which emits light by applying ultraviolet thereto is known. Recording agent which uses the pigment is hard to be recognized by naked eyes under visible light, and is used for forgery detection, events in the dark, or creation of post at an attraction by using characteristics of the pigment which is recognizable when ultraviolet is applied. However, utilization of the recording agent including ultraviolet emitting pigment is still not enough from the viewpoint of preventing an image forming apparatus from abnormally operating and improving convenience.

### DESCRIPTION OF THE DRAWINGS

FIG. 1 is an external view illustrating an entire configuration example of an image forming apparatus according to some embodiments of the invention described herein.

FIG. 2 is a block diagram illustrating a detailed configuration of an optical system of an image reading unit according to some embodiments of the invention described herein.

FIG. 3 is a functional block diagram illustrating a configuration of the image forming apparatus according to some embodiments of the invention described herein.

FIG. 4 is a flowchart illustrating a flow of image formation processing of the image forming apparatus according to some embodiments of the invention described herein.

FIG. 5 is a flowchart illustrating a flow of image reading processing of the image forming apparatus according to some embodiments of the invention described herein.

FIG. 6 is a specific example of a document in which document information and a mark are formed as an image by using UV-emitting toner, according to some embodiments of the invention described herein.

FIG. 7 is a specific example of image information when the image forming apparatus reads an image of the document, according to some embodiments of the invention described herein.

FIG. 8 is a schematic diagram illustrating a configuration example of the image reading unit according to some embodiments of the invention described herein.

FIG. 9 is a view illustrating a specific example if an original document is inappropriately disposed.

FIG. 10 is a diagram illustrating image data generated based on a mark which is formed as an image by using the UV-emitting toner, according to some embodiments of the invention described herein.

### DETAILED DESCRIPTION

An object of an exemplary embodiment is to provide an image forming apparatus and an image forming method which can reduce an operation error of original document disposition at the time of copying an original document and reading an image by using recording agent such as toner or ink (hereinafter, referred to as “UV-emitting toner” or “UV-emitting ink”) emitting light by ultraviolet.

In general, according to one embodiment, an image forming apparatus includes an image reading unit, a recognition unit, and an image data generation unit. The image reading unit can generate image data by reading an original document image having a first image which can be formed by first recording agent emitting light under ultraviolet light and a second image which can be formed by second recording agent that is recognizable under visible light. The recognition unit can recognize position information of the second image from image data of the first image which is read by the image reading unit. The image data generation unit can generate corrected image data which is obtained by correcting image data of the second image based on the position information.

Hereinafter, an image forming apparatus and an image forming method according to an embodiment will be described with reference to the drawings.

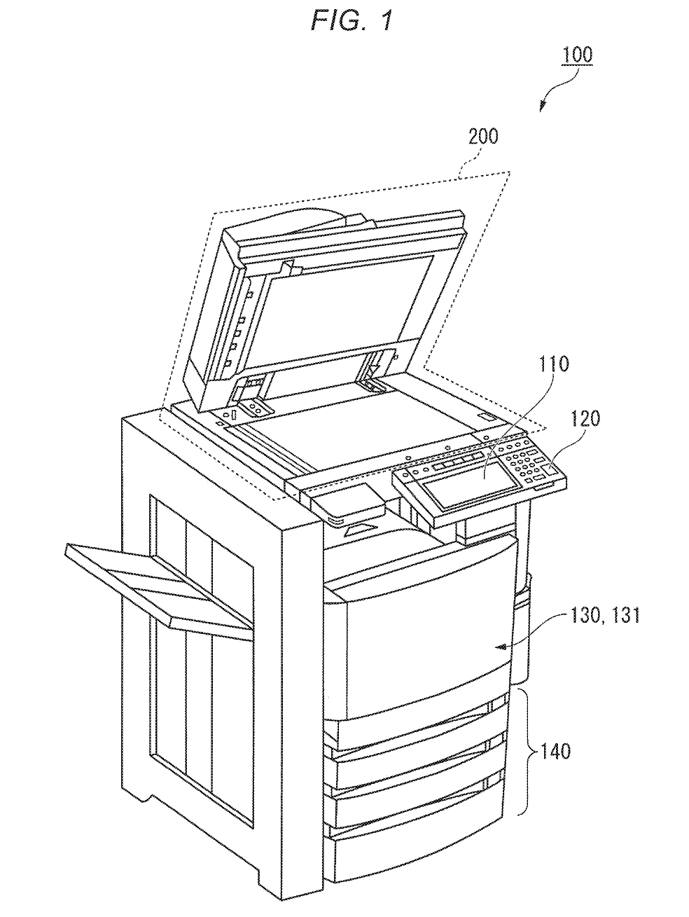

FIG. 1 is an external view illustrating an entire configuration example of an image forming apparatus 100 according to an embodiment. The image forming apparatus 100 is, for example, a complex machine. The image forming apparatus 100 can include a display 110, a control panel 120, a first printer unit 130, a second printer unit 131, a sheet containing unit 140, and an image reading unit 200. The first printer unit 130 and the second printer unit 131 of the image forming apparatus 100 may be devices which fix a toner image, and may be an ink jet type.

The image forming apparatus 100 can form an image on a sheet by using recording agent such as toner. The sheet is, for example, paper or label paper. The sheet may be any material, as long as the image forming apparatus 100 can form an image on a surface thereof. The sheet can be one aspect of an image formation medium.

The display 110 can be an image displaying device such as a liquid crystal display or an organic electro luminescence (EL) display. The display 110 can display various types of information relating to the image forming apparatus 100.

The control panel 120 can include a plurality of buttons. The control panel 120 can accept an operation of a user. The control panel 120 can output a signal according to an operation performed by the user to a control unit of the image forming apparatus 100. The display 110 and the control panel 120 may be configured as a touch panel of one piece. The control panel 120 can be one aspect of an input unit.

The first printer unit 130 can form an image on the sheet, based on image information generated by the image reading unit 200 or image information received through a communication path. The first printer unit 130 can form an image in accordance with, for example, the following processing. An image forming unit of the first printer unit 130 can form an electrostatic latent image on a photoconductive drum (not illustrated) based on the image information. The image forming unit of the first printer unit 130 can form a visible image by adhering the toner to the electrostatic latent image. A transfer unit of the first printer unit 130 can transfer the visible image onto a sheet. A fixing unit of the first printer unit 130 can fix the visible image onto the sheet by heating and pressurizing the sheet. The sheet on which an image is formed may be the sheet contained in the sheet containing unit 140 or may be inserted by hand. In some embodiments, the first printer unit 130 performs image formation by using normal toner (hereinafter, referred to as “normal toner”) having pigment such as carbon black which can be recognized under visible light, in the present embodiment. The first printer unit 130 can be one aspect of a second image forming unit. The normal toner can be one aspect of second recording agent.

The second printer unit 131 can form an image on the sheet, based on the image information generated by the image reading unit 200 or the image information received through the communication path. The second printer unit 131 can form an image by using the same processing as the first printer unit 130. In some embodiments, the second printer unit 131 forms the image by using a UV-emitting toner which emits light if ultraviolet light is applied. In some embodiments, the ultraviolet light has a short wavelength (approximately 350 to 380 nm). The second printer unit 131 can be one aspect of a first image forming unit. The UV-emitting toner can be one aspect of first recording agent.

The sheet containing unit 140 can contain a sheet which is used for image formation in the printer unit.

The image reading unit 200 can read image information of a read target as brightness and darkness of light. The image reading unit 200 can record the image information which is read. The recorded image information may be transmitted to other information processing devices through a network. The recorded image information may be formed as an image on the sheet by the printer unit.

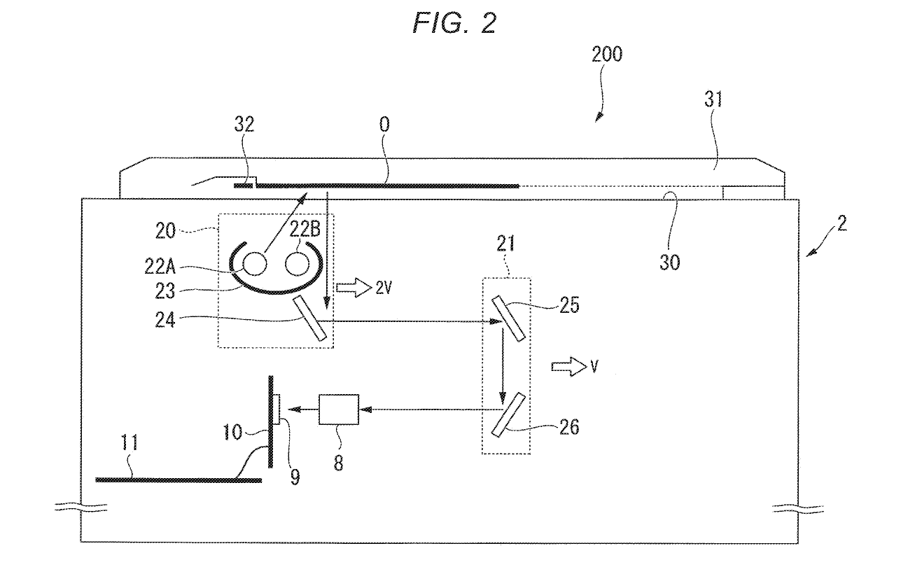

FIG. 2 is a block diagram illustrating a detailed configuration of an optical system of the image reading unit 200 according to the embodiment.

The image reading unit 200 can include a first carriage 20, a second carriage 21, a condensing lens 8, a CCD sensor substrate 10 in which a CCD sensor 9 is mounted, a control substrate 11, and the like.

The first carriage 20 can include a light source 22A, a light source 22B, a reflector 23 which corrects light distribution characteristics of the light sources 22A and 22B, and a first mirror 24, and moves at a speed of 2V in an arrow direction (sub scanning direction) of FIG. 2 when an original document is read. The light source 22A can emit white light which can be configured by light of a Xenon lamp or the like. The light source 22B can emit ultraviolet light (for example, with a short wavelength such as approximately 350 to 380 nm). Hereinafter, when it is not distinguished which of the light sources 22A and 22B is used, it will be simply referred to as a light source 22.

Meanwhile, the second carriage 21 can include a second mirror 25 and a third mirror 26, and can move at a speed of V in the sub scanning direction. By setting a movement speed of the second carriage 21 to half the speed of the first carriage 20, a length of an optical path from the light source 22 to the CCD sensor 9 can be maintained constant although the light source 22 moves in the sub scanning direction.

An original document glass table 30 for placing an original document O thereon, a document pressing cover 31 which presses the original document O so as not to float, and a white reference plate 32 which becomes a reference of white color can be provided on an upper side of a reading unit 2.

Light which is emitted from the light source 22 can pass through the original document glass table 30 and be incident on the original document O. Light which is reflected from the original document O can be reflected from the first mirror 24, the second mirror 25, and the third mirror 26, pass through the condensing lens 8, and form an image on a light receiving surface of the CCD sensor 9. The CCD sensor 9 can be mounted on the CCD sensor substrate 10 and can be controlled by a control signal which is input from the control substrate 11.

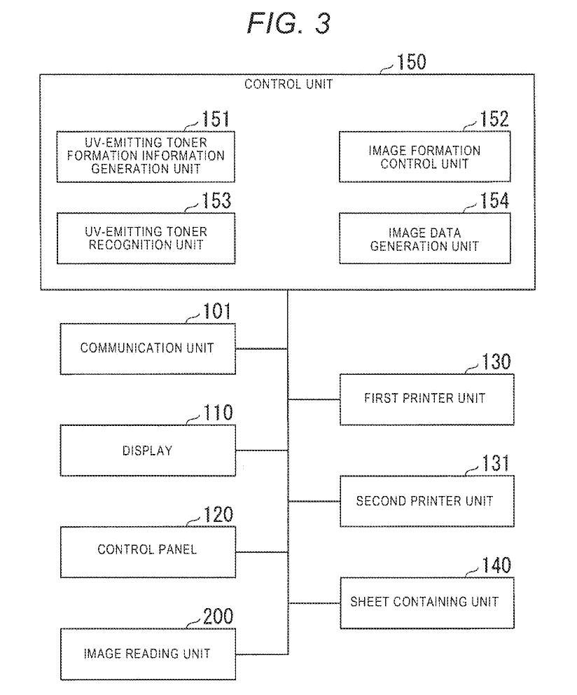

FIG. 3 is a functional block diagram illustrating a configuration of the image forming apparatus 100 according to the embodiment. The image forming apparatus 100 can include a communication unit 101, the display 110, the control panel 120, the first printer unit 130, the second printer unit 131, the sheet containing unit 140, a control unit 150, and the image reading unit 200. Configurations of the display 110, the control panel 120, the first printer unit 130, the second printer unit 131, the sheet containing unit 140, and the image reading unit 200 can be the same as the aforementioned configuration, and thus, description thereof will be omitted.

The communication unit 101 can be a network interface. The communication unit 101 can be communicably connected to an information processing device such as a personal computer or a server through a network. The communication unit 101 can be connected by using a communication method such as the local area network (LAN) or the public switched telephone networks (PSTN).

The control unit 150 can control operations of each unit of the image forming apparatus 100. The control unit 150 can be configured by a device including, for example, a central processing unit (CPU) and a random access memory (RAM). The control unit 150 can function as a UV-emitting toner formation information generation unit 151, an image formation control unit 152, a UV-emitting toner recognition unit 153, and an image data generation unit 154 by executing an image forming device control program.

The control unit 150 can accept a job through the communication unit 101 or the control panel 120. The job can include an image reading job and an image forming job. The image reading job can read an original document disposed in the original document glass table 30 of the image reading unit 200. The image forming job can form an image, based on image data.

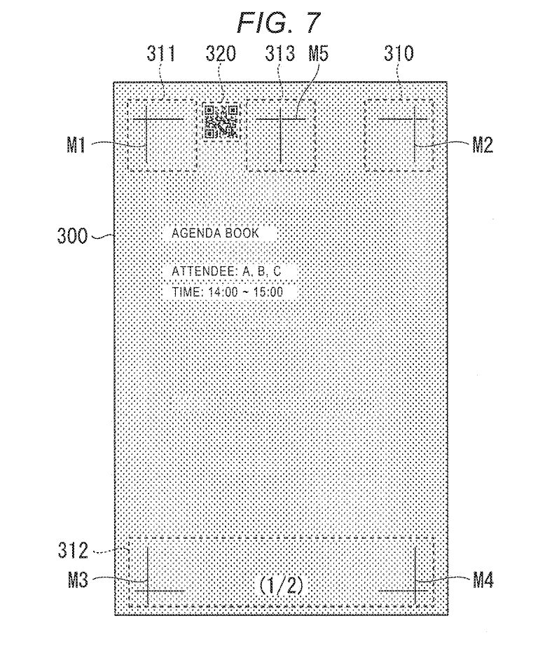

The control unit 150 can determine an image formation mode of the image formation control unit 152 if accepting the image forming job. The control unit 150 can accept the image formation mode from a user through the control panel 120. The image formation mode can determine which toner is used to form an image, when the image formation control unit 152 performs image formation processing. The image formation mode may be included in the image forming job. The image formation mode can include two modes—a normal toner mode and a UV-emitting toner mode. The normal toner mode is a mode in which an image of the image data included in the image forming job is formed by using normal toner. In contrast, the UV-emitting toner mode is a mode in which an image of predetermined information is formed by using UV-emitting toner in addition to forming the image of the image data by using the normal toner. The predetermined information is defined by UV-emitting toner formation information. The UV-emitting toner formation information can form an image such as a position mark representing an image region of an original document and/or a QR connection destination (registered trademark) by using the UV-emitting toner. The position mark can be a line which is drawn as a marker for aligning an original document image, and can be a so-called register mark which is represented by a cross mark or the like. The position mark can include marks (refer to M1 to M4 of FIG. 7) representing four corners of the image region and a center mark (refer to M5 of FIG. 7) representing the center of the image region. The center mark can also represent top and bottom, or left and right by being formed at one place of the top and bottom or the left and right of the original document. A shape of the position mark is not limited to the cross mark. The position mark may be any one as long as the image region can be discriminated. Hereinafter, when it is not distinguished which of the position marks M1 to M5 is used, it will be simply referred to as a mark M. The position mark can be one aspect of area information. The mark M can be one aspect of an area image.

The control unit 150 can determine a read mode of an original document by using the image reading unit 200 if accepting the image reading job. The control unit 150 can accept the read mode from a user through the control panel 120. The read mode can determine which light source is used to read an image when the image reading unit 200 reads an image. The read mode may be included in the image reading job. The read mode can include two modes—a normal read mode and an ultraviolet read mode. The normal read mode is a mode in which a visible image formed by using the normal toner is read as the light source 22A emits light. In contrast, the ultraviolet read mode is a mode in which an invisible image formed by using the UV-emitting toner or UV-emitting ink is read as the light source 22B emits light, in addition to reading the image in a visible state as the light source 22A emits light.

The UV-emitting toner formation information generation unit 151 can output UV-emitting toner formation information to the image formation control unit 152. The UV-emitting toner formation information generation unit 151 can generate the UV-emitting toner formation information based on information accepted through the control panel 120. The UV-emitting toner formation information generation unit 151 may generate the UV-emitting toner formation information based on information accepted through the communication unit 101. The UV-emitting toner formation information can be one aspect of image formation information.

The image formation control unit 152 can perform image formation processing by controlling the first printer unit 130 and the second printer unit 131. Hereinafter, when it is not distinguished which of the first printer unit 130 and the second printer unit 131 is used, it is simply referred to as a “printer unit”.

The image formation control unit 152 can perform first image formation processing or second image formation processing based on the accepted information. Processing of forming an image by using the normal toner and the UV-emitting toner can be performed in the first image formation processing. Processing of forming an image by using the normal toner can be performed in the second image formation processing. If the UV-emitting toner formation information is included in the accepted information, the image formation control unit 152 can perform the first image formation processing. If the UV-emitting toner formation information is not included in the accepted information, the image formation control unit 152 can perform the second image formation processing.

The UV-emitting toner recognition unit 153 can acquire a region where an image is formed by using the UV-emitting toner, which is included in the image information read by the image reading unit 200. The UV-emitting toner recognition unit 153 can output instruction information indicating predetermined instruction to the image data generation unit 154 based on the acquired region. For example, a slope of the image information which is read can be corrected in accordance with the predetermined instruction, based on the mark M formed by using the UV-emitting toner. In addition, the image information which is read can be upside down in accordance with the predetermined instruction, based on the mark M formed by using the UV-emitting toner. Furthermore, the predetermined instruction may be instruction by which the image information that is read is stored in a predetermined file path. In addition, if image information which is read is copied by a user, the UV-emitting toner recognition unit 153 may cause the UV-emitting toner formation information generation unit 151 to generate the UV-emitting toner formation information based on the region where an image is formed by using the UV-emitting toner. The UV-emitting toner recognition unit 153 can operate if an image is read in the ultraviolet read mode. The UV-emitting toner recognition unit 153 can be one aspect of a recognition unit.

The image data generation unit 154 can generate image data based on the predetermined instruction accepted from the UV-emitting toner recognition unit 153 and the image information which is read. The image data generation unit 154 can output the generated image data to the communication unit 101. The image data generation unit 154 may store the generated image data to a file path designated by the predetermined instruction. For example, the image data generation unit 154 may store the generated image data in a storage unit (not illustrated) of the image forming apparatus 100. If the image information which is read is copied, the image data generation unit 154 can output the image data to the image formation control unit 152. The image formation control unit 152 can perform the image formation processing based on image data, if accepting the image data.

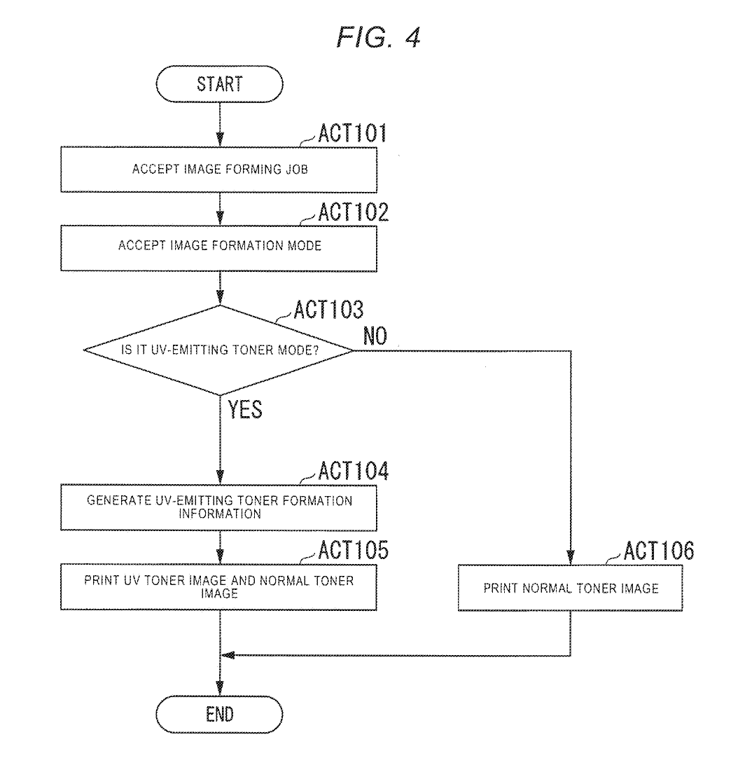

FIG. 4 is a flowchart illustrating a flow of the image formation processing of the image forming apparatus 100 according to the embodiment. The control unit 150 of the image forming apparatus 100 can accept the image forming job (ACT 101). The control panel 120 of the image forming apparatus 100 can accept a mode at the time of image formation processing from a user (ACT 102). The control unit 150 can determine whether or not the accepted image formation mode is the UV-emitting toner mode (ACT 103). If the image formation mode is the UV-emitting toner mode (ACT 103: YES), the UV-emitting toner formation information generation unit 151 can generate the UV-emitting toner formation information, based on the information accepted from the control panel 120 (ACT 104). The image formation control unit 152 can form an image in the first printer unit 130 and the second printer unit 131, based on the image data included in the image forming job and the UV-emitting toner formation information (ACT 105). If the image formation mode is not the UV-emitting toner mode (ACT 103: NO), the image formation control unit 152 can form an image in the first printer unit 130, based on the image data included in the image forming job (ACT 106).

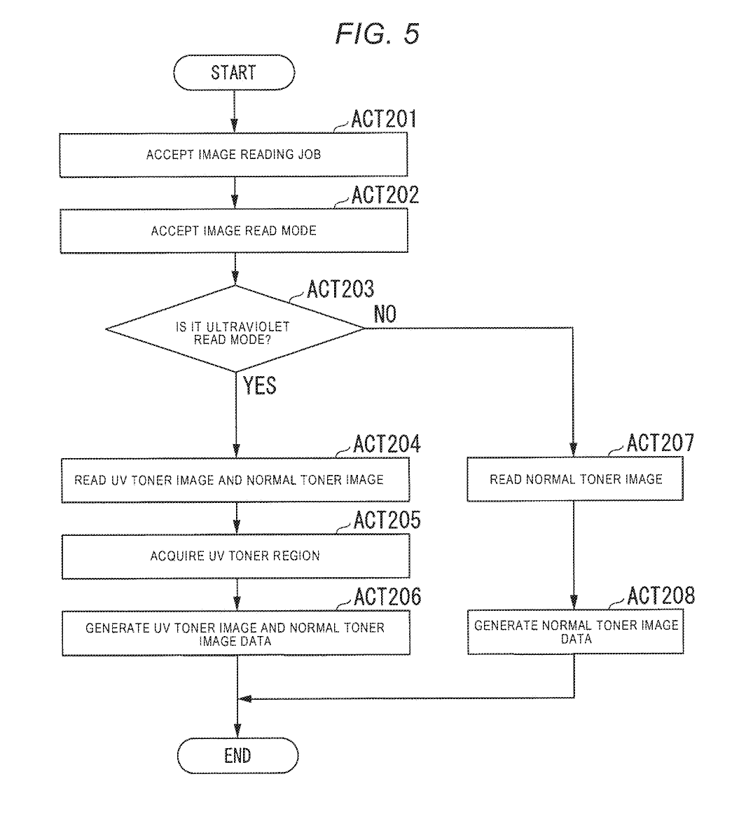

FIG. 5 is a flowchart illustrating a flow of the image reading processing of the image forming apparatus 100 according to the embodiment. The control unit 150 of the image forming apparatus 100 can accept the image reading job (ACT 201). The control panel 120 of the image forming apparatus 100 can accept a mode at the time of image reading processing from a user (ACT 202). The control unit 150 can determine whether or not the accepted image read mode is the ultraviolet read mode (ACT 203).

If the image read mode is the ultraviolet read mode (ACT 203: YES), the image reading unit 200 of the image forming apparatus 100 can perform read processing of a UV toner image and a normal toner image (ACT 204). The UV-emitting toner recognition unit 153 of the image forming apparatus 100 can acquire a region where an image is formed by using the UV-emitting toner from image information read by the image reading unit 200 (ACT 205). The image data generation unit 154 can generate image data of the UV toner image and the normal toner image based on region and image information acquired by the UV-emitting toner recognition unit 153 (ACT 206). If the image read mode is not the ultraviolet read mode (ACT 203: NO), the image reading unit 200 of the image forming apparatus 100 can perform the read processing of the normal toner image (ACT 207). The image data generation unit 154 can generate image data of the normal toner image based on the image information which is read (ACT 208).

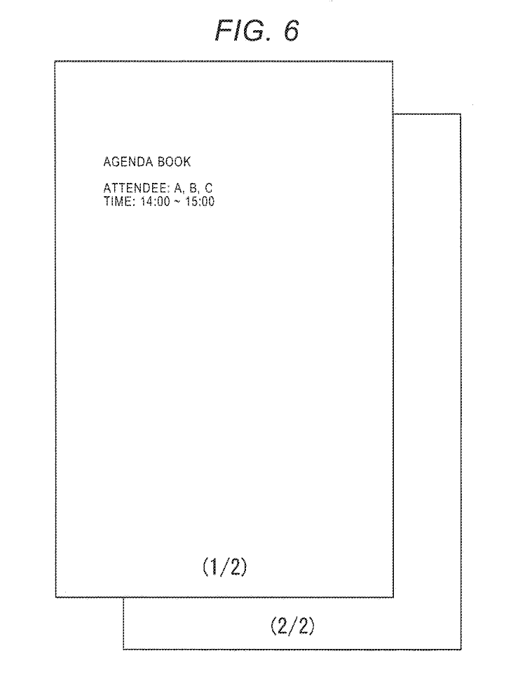

FIG. 6 is a specific example of a document in which document information and the mark M are formed as an image by using the UV-emitting toner. The document information and the mark M are formed as an image on the document illustrated in FIG. 6 by using the UV-emitting toner. The part where the image is formed by using the UV-emitting toner can be hard to be seen with naked eyes. Hence, a user can use the document in the same manner as a document where an image is formed by using the normal toner.

FIG. 7 is a specific example of the image information when the image forming apparatus 100 according to the embodiment reads an image of the document. A region 300 is image information that the image reading unit 200 acquires when an image of the document is read in the ultraviolet read mode. The region 300 includes a region 310, a region 311, a region 312, a region 313, and a region 320. The regions 310 to 312 include the marks M1 to M4 for correcting a slope of the image information which is read. The image data generation unit 154 can correct the slope of the image information which is read, based on the marks M of the regions 310 to 312. Specifically, correction can be performed such that lines which connect each of the marks M1 to M4 are parallel in a main scanning direction or a sub scanning direction. The region 313 includes the mark M5 for correcting top and bottom of the image information which is read. The mark M5 is a position mark for correcting top and bottom of the image information which is read. For example, the image information can be corrected such that the mark M5 is disposed on a far side from a point of view of a user. The region 320 is a QR code. For example, original document information on an original document which is read can be recorded in the QR code.

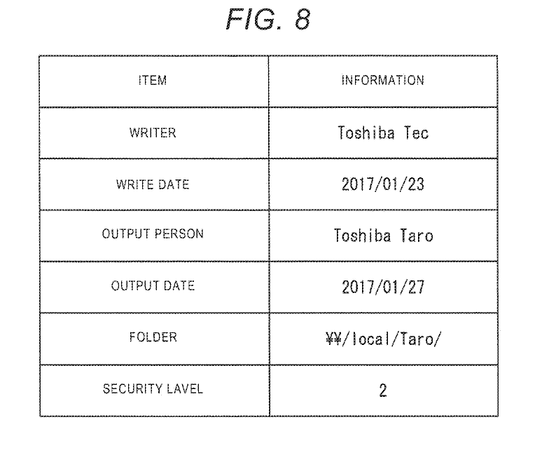

FIG. 8 is a diagram illustrating a specific example of the original document information recorded in the QR code. The original document information can include one or more values of a writer, a write date, an output person, an output date, a folder, and a security level. A name of a current writer of the original document can be recorded in the writer. A date when an original document is written can be recorded in the write date. A person who forms an image of the original document on a sheet can be recorded in the output person. A date when an image of the original document is formed on the sheet can be recorded in the output date. A path in which image information that is read is recorded can be recorded in the folder. A range in which the image information may be published can be defined in the security level.

In the example illustrated in FIG. 8, a value of the writer is “Toshiba Tec”, a value of the write date is “2017/01/23”, a value of the output person is “Toshiba Taro”, a value of the output date is “2017/01/27”, a value of the folder is “¥¥/local/Taro”, and a value of the security level is “confidential”. Hence, according to the original document information, it can be seen that the original document is written by Toshiba Tec on Jan. 23, 2017. In addition, it can be seen that an image of the original document is formed by Toshiba Taro on Jan. 27, 2017. Furthermore, it can be seen that the original document is kept in ¥¥/local/Taro and the value of the security level is “confidential”. The original document information illustrated in FIG. 8 is only a specific example. Accordingly, the original document information may be configured by an aspect different from FIG. 8. For example, the original document information may have the number of outputs or control information on the image forming apparatus 100. The control information on the image forming apparatus 100 can be, for example, information which sends copy protection instructions to the image forming apparatus 100.

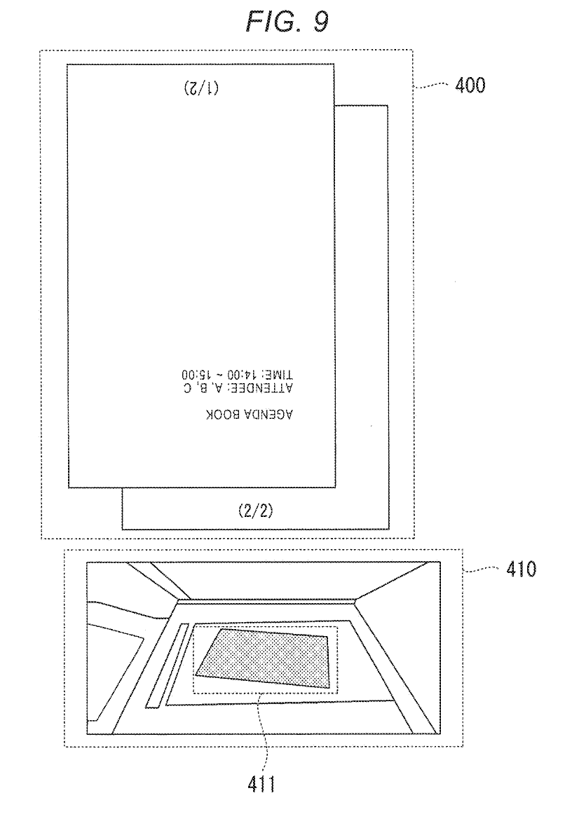

FIG. 9 is a view illustrating a specific example when the original document is inappropriately disposed. A region 400 represents two original documents which are read by the image forming apparatus 100. One of the two original documents is upside down. Hence, if an image of the two original documents is read, image data in which one original document is upside down is generated. A region 410 represents a part of the image reading unit 200 of the image forming apparatus 100. A region 411 represents an original document disposed on the original document glass table 30. The original document included in the region 411 is disposed in a tilted state. Hence, if an image is read, image data in a tilted state is generated.

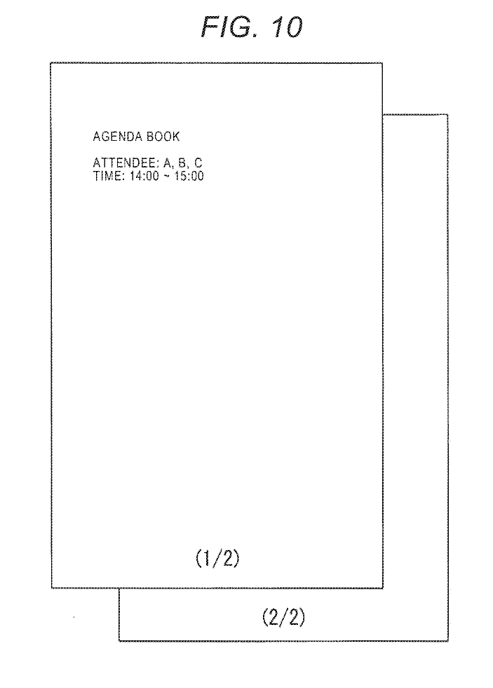

FIG. 10 is a diagram illustrating the image data generated based on the position mark whose image is formed by using the UV-emitting toner. If an image is read in the ultraviolet read mode, the image data generation unit 154 can correct the original document based on the position mark whose image is formed by using the UV-emitting toner and generates image data. For example, if an image of the original document is read upside down, the image data generation unit 154 can correct the image information which is upside down, and generate the image data. In addition, if the original document is read in a tilted state, the image data generation unit 154 can correct the tilt based on the position mark whose image is formed by using the UV-emitting toner, and generate the image data. Hence, a user can reduce an operation error when the original document is copied and the image is read.

The image forming apparatus 100 configured as such can acquire an image which is formed by using the UV-emitting toner by the UV-emitting toner recognition unit 153, if an image of the original document whose image is formed by using the UV-emitting toner is read in the ultraviolet read mode. The UV-emitting toner recognition unit 153 can output instruction on the image information which is read to the image data generation unit 154, based on the acquired image. The image data generation unit 154 can correct the image information which is read, based on the instruction which is output. Hence, a user can reduce an operation error when the original document is copied and the image is read.

According to at least one embodiment described above, it is possible to reduce an operation error when an original document is copied and an image is read, by including the UV-emitting toner recognition unit 153 and the image data generation unit 154.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image forming apparatus comprising:
an image reader configured to generate image data by reading an original image having a first image which is formed by a first recording agent that emits light under ultraviolet light and a second image which is formed by a second recording agent that is readable under visible light;
an image recognizer configured to recognize position information of the second image using the image data of the first image which is read by the image reader to recognize a tilted state of the second image; and
an image data generator configured to generate corrected image data of the second image which is obtained by correcting the tilted state of the second image-based on the position information.

2. The apparatus according to claim 1, wherein the original image is a document image.

3. The apparatus according to claim 1, further comprising a first printer unit configured to form an image by using the first recording agent which emits light under the ultraviolet light.

4. The apparatus according to claim 1, further comprising a second printer unit configured to form an image by using the second recording agent which is readable under the visible light.

5. The apparatus according to claim 4, wherein the second printer unit forms an image on an image formation medium using the corrected image data that is generated by the image data generator.

6. The apparatus according to claim 3, wherein the first printer unit adds an area image comprising area information onto the image formation medium, wherein the area information indicates an image region of the image.

7. The apparatus according to claim 1, further comprising:
a first printer unit configured to form an image by using the first recording agent which emits light under the ultraviolet light; and
a second printer unit configured to form an image by using the second recording agent which is readable under the visible light,
wherein the second printer unit forms an image on an image formation medium based on the corrected image data that is generated by the image data generator, and
wherein the first printer unit adds an area image comprising area information onto the image formation medium, wherein the area information indicates an image region of the image.

8. The apparatus according to claim 3, further comprising an image formation controller configured to receive UV-emitting toner formation information and control the first printer unit.

9. The apparatus according to claim 8, further comprising a UV-emitting toner formation information generator configured to output UV-emitting toner formation information to the image formation controller.

10. The apparatus according to claim 1, wherein the image recognizer comprises a UV-emitting toner image recognizer configured to recognize image data generated under ultraviolet light.

11. The apparatus according to claim 7, further comprising:
an image formation controller configured to receive UV-emitting toner formation information and control the first printer unit and the second printer unit;
a UV-emitting toner formation information generator configured to output UV-emitting toner formation information to the image formation controller; and
wherein the image recognizer comprises a UV-emitting toner image recognizer configured to recognize image data generated under ultraviolet light.

12. An image forming method comprising:
generating image data by reading an original image having a first image that is formed by a first recording agent that emits light under ultraviolet light and a second image that is formed by a second recording agent which is readable under visible light, by using an image reader;
calculating position information of the second image using image data of the first image to recognize a tilted state of the second image; and
generating corrected image data of the second image by correcting the tilted state of the second image based on the position information.

13. The method according to claim 12, wherein the original image is a document image.

14. The method according to claim 12, further comprising forming the second image using the second recording agent that is readable under the visible light onto an image formation medium based on the corrected image data.

15. The method according to claim 12, further comprising adding the first image indicating area information indicating an image region of the second image onto the image formation medium by using the first recording agent.

16. The method according to claim 12, further comprising:
forming the second image using the second recording agent that is readable under the visible light onto an image formation medium based on the corrected image data which is generated at the generating of the corrected image data; and
adding the first image indicating area information indicating an image region of the second image onto the image formation medium by using the first recording agent.

17. The method according to claim 12, further comprising recognizing a QR code from the image data of the first image.

18. The method according to claim 12, further comprising forming a QR code onto an image formation medium using the first recording agent.

19. The method of claim 17, wherein the QR code encodes one or more values of a writer, a write date, an output person, an output date, a folder, and a security level.

20. The method of claim 18, wherein the QR code encodes one or more values of a writer, a write date, an output person, an output date, a folder, and a security level.

21. The apparatus of claim 1, wherein the first image comprise a plurality of marks positioned on corners of the original image, and wherein the image recognizer is configured to recognize a tilted state of the second image where one or more lines connecting the marks are not aligned to a scanning direction of the image reader.

22. The method of claim 12, wherein the first image comprise a plurality of marks positioned on corners of the original image, and the method comprises recognizing a tilted state of the second image where one or more lines connecting the marks are not aligned to a scanning direction of the image reader.
